(19) United States
(12) Patent Application Publication
(10) Pub. No.: US 2007/0226764 A1
(43) Pub. Date: Sep. 27, 2007

(54) Mobile communication based television standard selection apparatus

(76) Inventor: Tobias Melin, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/388,050

(22) Filed: Mar. 23, 2006

(51) Int. Cl. H04N 7/16

(52) U.S. Cl. 725/62; 348/14.01

(57) ABSTRACT

This invention discloses a mobile communication equipment operable to automatically select a television standard according to the mobile communication network said equipment is located in. Since different television standards need specific demodulation, respectively, it is essential to select the correct television standard like e.g. PAL or NTSC to receive proper images and films. This object is solved by a mobile communication equipment adapted for wireless communication in a wireless communication system, comprising an analysing device being operable to determine a television standard, said analysing device comprising a determining device operable to automatically determine country-specific data, and a mapping device operable to map said country-specific data to a specific television standard.

### TECHNICAL FIELD OF THE INVENTION

The present invention relates to the field of TV (Television) standard selection processes and in particularly to the automatic selection of TV standards by means of mobile communication and/or its devices.

Different TV standards are used in different countries around the world. While North America and portions of South America are using a TV standard called NTSC (National Television System Committee), Europe, Asia and portions of Africa are mainly involved with PAL (Phase Alternating Line) and Russia, France and portions of Africa with SECAM (Sequentiel couleur avec memoire). These TV standards are each compatible to the prior black & white TV transmissions, but are based on different characteristics and transmission properties for the generation of colored images and films, respectively.

To receive an appropriate and feasible video signal for an output device, the correct TV standard has to be used to demodulate a TV signal into a video signal like RGB (Red Green Blue). Otherwise the output device cannot interpret the video signal.

Therefore the correct TV standard has to be selected. The state of the art is to let the user manually select the TV standard by a setting in the phone. This phone is connected to an output device and is operable to generate a video signal to display graphics on said output device.

But there are problems, which cannot be solved or are even implemented by the state of the art:

The manual configuration is always involved with possible input errors produced by the user. The user may not always know which TV standard to choose, thus may also set an incorrect configuration.

### SUMMARY

An aspect of of the present invention is to provide an apparatus operable to determine the TV standard of a country automatically.

Another aspect of the invention is to support a user when setting a TV standard.

Another aspect of the invention is to simplify the configuration of TV devices, since most of the people do not know anything about TV standards.

Another aspect of the invention is to allow a determination of the TV standard by means of mobile communication equipments.

These and other aspects of the invention are solved by a mobile communication equipment based television standard selection apparatus. Said mobile communication equipment adapted for wireless communication in a wireless communication system, comprises an analysing device being operable to determine a television standard, wherein said analysing device comprising a determining device operable to automatically determine country-specific data, and a mapping device operable to map said country-specific data to a specific television standard.

According to another aspect the determining device determines said country-specific data via a user identification device.

According to another aspect the user identification device comprises an ID memory card device operable to store country-specific data.

According to another aspect the determining device determines said country-specific data from information received via the wireless communication system.

According to another aspect the determining device comprises an information receiving device operable to receive country-specific data from a base station.

According to another aspect the determining device determines said country-specific data from country-specific characteristics of the wireless communication system.

According to another aspect the determining device comprises a frequency filter device operable to determine the country-specific characteristics by means of a frequency determination.

According to another aspect the mobile communication equipment comprises a user input device operable to input country-specific data by a user.

According to another aspect the mobile communication equipment comprises a television signal converter device operable to convert television signals into video signals according to said determined television standard.

According to another aspect the television signal converter device is operable to process the television standards PAL, NTSC and SECAM.

According to another aspect the mobile communication equipment comprises a television signal receiver device operable to receive television signals.

According to another aspect the television signal receiver device comprises a storage device, said storage device being operable to provide television signals to said television signal converter device.

According to another aspect the mobile communication equipment comprises a video signal output device operable to output video signals.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The above and other objects, features and advantages of the present invention will become more apparent from the following detailed description when taken in conjunction with the accompanying drawings, in which:

FIG. 1 shows a schematical view of an example of a mobile communication equipment comprising an embodiment of the present invention,

FIG. 2 shows an example of a setup of a mobile phone and a TV device via a cable, said mobile phone comprising an embodiment of the present invention,

FIG. 3 shows an example of a mobile phone, said mobile phone comprising an embodiment of the present invention,

FIG. 4 shows an example of a TV device, said TV device comprising an embodiment of the present invention,

FIG. 5 shows an example of a flow chart for selecting a TV standard.

### DETAILED DESCRIPTION OF EMBODIMENT

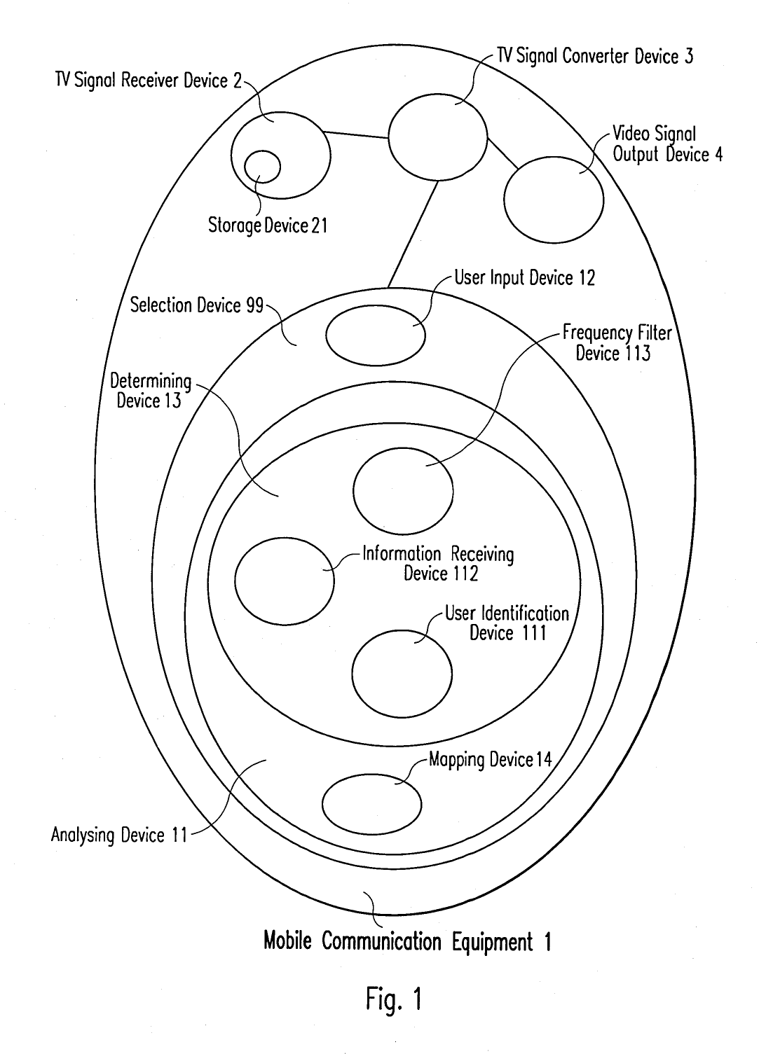

FIG. 1 shows a schematical view of an example of a mobile communication equipment 1 operable to output a video signal based on a TV signal, whereby the TV standard was determined by an analyzing device 11 or selected by a user via a user input device 12, said devices 11 and 12 being part of said mobile communication equipment 1. Depending on the TV signal a specific TV standard demodulation has to be performed to correctly display the images and/or films transmitted by said signal, whereby said TV standard is varying from country to country and/or region to region. The term mobile communication equipment includes portable radio communication equipment. The term portable radio communication equipment, which herein after is referred to as a mobile radio terminal, includes all equipment such as mobile telephones, pagers, communicators, i.e. electronic organizers, smartphones or the like. The mobile equipment is adapted to communicate in a wireless communication system and has all necessary elements, which are not shown and explained for sake of clarity.

The mobile communication equipment 1 itself comprises a TV signal receiver device 2, a TV signal converter device 3, a video signal output device 4 and a selection device 99. Other examples, wherein the mobile communication equipment 1 comprises either said TV signal converter device 3, or said TV signal receiver device 2 and said TV signal converter device 3, or said TV signal converter device 3 and a video signal output device 4, are possible but not shown in the drawings for the sake of clarity. In the other examples where not all said devices 2 to 4 are part of the mobile communication equipment 1, respectively, these devices are located in separate devices of said equipment 1, but still have the same or similar operability described later.

Furthermore, the selection device 99 comprises a user input device 12 and an analyzing device 11, wherein said analyzing device 11 comprises an embodiment of the present invention.

The TV signal receiver device 2 is operable to receive a TV signal. The reception of the TV signal can either be performed via a wireless communication system or by other auxiliary devices operable like the TV signal receiver devices 2, said auxiliary device using a cable or any other means known to a skilled person instead of a wireless communication system. Eventually the TV signal receiver device 2 is operable to provide a TV signal to a TV signal converter device 3. In another example the receiver device 2 is the same as the antenna of a mobile communication device known to a skilled person operable to connect to a cellular network for mobile communication and/or receive data of TV signals. In another example, the TV signal receiver device 2 comprises a storage device 21. Said storage device 21 is operable to store TV signals in an unmodulated format and send said signal to the TV signal converter device 3. The storage device 21 comprises for example a video recorder for recording a video tape or a memory chip for storing the TV signals but is not limited to these means.

The video signal output device 4 is operable to receive the demodulated/converted signal, also called video signal described below, from the TV signal converter device 3 and to output said signal. The video signal output device 4 is for example a CRT (cathode ray tube) TV, a LCD (liquid crystal display) TV, a plasma TV, a projector or any other means for outputting said signal known to a skilled person.

The selection device 99 is operable to select and determine the country TV standard and to change the demodulation/conversion of the TV signal converter device 3 according to the determined country's TV standard. The user input device 12 is operable to receive input from a user that determines the country or country-specific data. Said country-specific data comprises e.g. coordinates indicating a position, frequencies used for mobile communication and the TV standard itself and other characteristics known to a skilled person.

The analyzing device 11 is operable to automatically determine the country and eventually the country's TV standard from received or detected country data comprising information about the country in which the mobile equipment is currently located or its respectively used TV standard. Nevertheless and if necessary, a user can override the automatic determination and manually set the TV standard via the user input device 12. Said analyzing device 11 comprises a mapping device 14 and a determining device 13. The determining device 13 is operable to determine the country or country-specific data by different devices and/or means described below. The mapping device 14 is operable to link data to a specific TV standard like for example SECAM (Sequentiel couleur avec memoire), PAL (Phase Alternating Line) and NTSC (National Television System Committee), said data being sent by the determining device 13 or user input device 12. The mapping device 14 comprises a non-volatile memory device (not shown in the figure) storing all countries, country-specific data and their respective TV standards, but the mapping device 14 is not limited to this example. The determining device 13 comprises a user identification device 111 and/or an information receiving device 112 and/or a frequency filter device 113. Each of these devices 111 to 113 is operable to determine a country or country-specific data.

The user identification device 111 is operable to store country-specific data and comprises for example an ID memory card, a SIM (Subscriber Identity Module) card or any other card which is operable to activate and/or identify a mobile phone in a communication network; this user identification device 111 can be inserted into the determining device 13 like a SIM card into a mobile telephone. The user identification device 111 has stored the information of the country of origin and/or other useful country-specific data, which help to determine the country.

The information receiving device 112 is operable to receive information via the wireless communication system by for example querying a base station (not shown in the figures), said base station being operable to provide mobile communication and connect to the telephone network, and requesting data like or regarding the current location and/or the name of the current country and/or the TV standard itself. In case the base station is sending welcome packages or some kind of a ping know to a skilled person, the information receiving device 112 is operable to receive these communication signals and filter out country-specific data.

The frequency filter device 113 is operable to measure and analyze the frequencies used for mobile communication and finally provide these frequencies to the mapping device 14. Since these frequencies differ from each other in many countries and/or regions, based on these results the current country and/or region is determined, respectively. When for example the information receiving device 112 is sending a request to a base station to receive information about the mobile communication network, the base station will only respond when the correct frequency was used by the information receiving device 112. Thus knowing which frequencies are used, the country and/or the region can be determined by the mapping device 14. Of course the frequency filter device 13 is not dependent on the information receiving device 112 but is also operable to recognize the frequency of the base station, said base station sending welcome packages or some kind of a ping know to a skilled person.

The TV signal converter device 3 is operable to convert the TV signal from different TV standards like PAL, SECAM and NTSC sent by the TV signal receiver device 2 into a video signal, which the video signal output device 4 can process properly. Said video signal comprises all signals, which are feasible for RGB (Red Green Blue), SCART (Syndicat des Constructeurs d'Appareils Radiorecepteurs et Televiseurs) or YUV (Y stands for the luminance component (the brightness) and U and V are the chrominance (color) components) connections, said signals are not depending on norms of countries and/or regions.

Other embodiments are possible, wherein the determining device 13 comprises at least one of the above-mentioned devices, or other TV standards and/or video signals are processed.

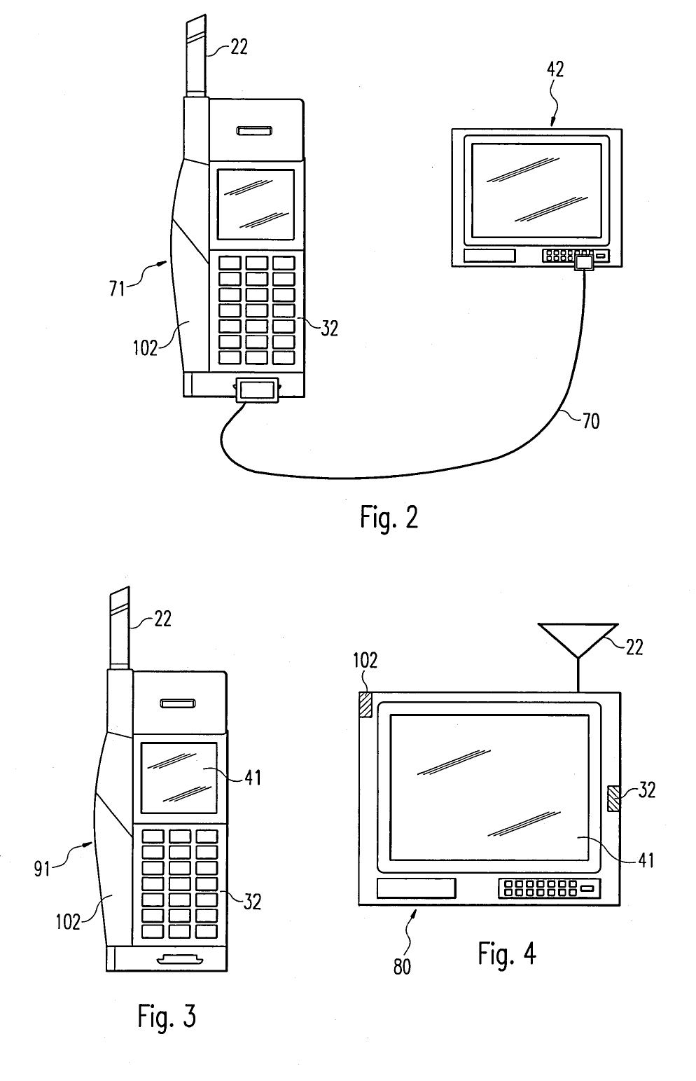

FIG. 2 shows an example of a setup of a mobile phone 71 and a video signal output device 42 via a cable 70, said mobile phone 71 comprising said mobile communication equipment described in FIG. 1, said mobile communication equipment comprising a TV signal receiver device 22, a TV signal converter device 32 and a selection device 102. All devices are the same as described in FIG. 1.

The mobile phone 71 is an electronic telecommunications device with the same basic capability as a conventional fixed-line telephone, but which is also entirely portable and is not required to be connected with a wire to the telephone network. The mobile phones 7 is operable to connect to the network using a wireless radio wave transmission technology. The mobile phone 71 communicates via a cellular network of base stations (not shown in figure), which are linked to the conventional telephone network. In this example the mobile phone is operable to receive TV signals and convert them into an appropriate video signal.

The cable 70 is operable to connect the mobile phone 71, in particular the TV signal converter device 32 within the mobile phone 71, with the video signal output device 42.

In this example the video signal output device 42 is a television of state of the art using a RGB, SCART and/or YUV—connection and can be connected via RGB, SCART or YUV cable or any other means known to a skilled person. The cable 70 is most likely CVBS (Colour Video Baseband Signal) or S-Video.

The devices 102 and 32 are within the housing of the mobile phone 71, preferably in an integrated circuit on a printed circuit board, thus their positions are within the mobile phone 71 can vary and are not explicitly shown.

FIG. 3 shows an example of a mobile phone 91, said mobile phone 91 comprising said mobile communication equipment described in FIG. 1, said mobile communication equipment comprising a video signal output device 41, a TV signal receiver device 22, a TV signal converter device 32 and a selection device 102. All devices are the same as described in FIG. 1.

The mobile phone 91 is the same as described in FIG. 2 and additionally comprises the ability to receive and output TV signals. Said TV signal receiver device 22 is operable to both receive TV signals and transmit mobile communication in this example. As known by a person skilled in the art, there might be also separate receiver devices for the different types of wireless radio wave transmission and reception. The device 41 is not limited to output TV signals but can also display data regarding the mobile phone 91 and its processes known to a skilled person.

The devices 102 and 32 are within the housing of the mobile phone 91, preferably in an integrated circuit on a printed circuit board, thus their positions are within the mobile phone 91 can vary and are not explicitly shown.

FIG. 4 shows an example of a TV device 80, said TV device 80 comprising said mobile communication equipment described in FIG. 1, said mobile communication equipment comprising a video signal output device 41, a TV signal receiver device 22, a TV signal converter device 32 and an analyzing device 102. All devices are the same as described in FIG. 1.

The TV device 80 is operable to receive moving pictures and sound over a distance. Said device 22 is operable to both receive TV signals and transmit mobile communication in this example. As known by a person skilled in the art, there might be also separate receiver devices for the different types of radio reception.

The devices 102 and 32 are within the housing of the TV device 80, preferably in an integrated circuit on a printed circuit board, thus their positions within the TV device 80 can vary and are not limited to the pointed out positions. By means of this TV device 80 a user does not have to select the proper TV standard.

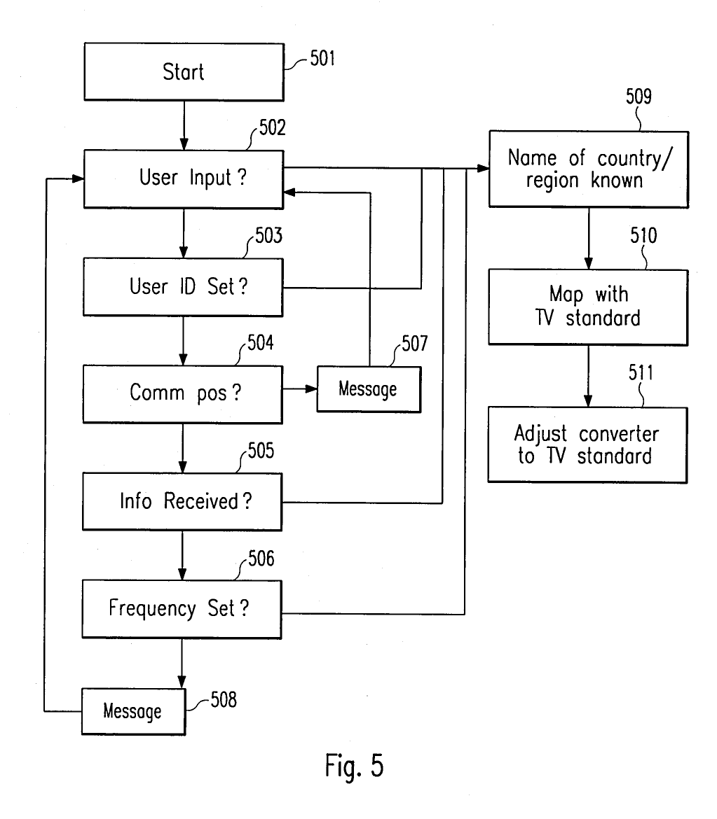

FIG. 5 shows an example of a flow chart for selecting a TV standard, said flow chart comprising the steps 501 to 511.

The flow chart starts from step 501 and continues to step 502. The “User Input?”—Step 502 is operable to control whether a user has manually set the country or the TV standard. If one of these values is set, then the process is continued at step 509. Otherwise the process goes to step 503, meaning that either no or no feasible data was entered. The “User ID Set?”—Step 503 is operable to control whether a user identification device is connected and appropriate data relating to the current country and/or region is available. If this country-specific data is available, then the process is continued at step 509. Otherwise the process goes to step 504. The “Comm pos?”—Step 504 is operable to control whether mobile communication with an available base station is possible. If there is no reception of mobile communication frequencies possible, then the process continues to step 507. When there is said reception, the process continues to step 505. The “Message”—Step 507 is operable to inform the user, that no reception of electromagnetic waves for mobile communication is possible, no country name was determined and that the process is restarted. Then the process loops back to step 502. The “Info Received?”—Step 505 is operable to control whether information was received via the wireless communication system or a query sent to the base station is answered, said information or answer providing the name of the country or any other relevant data for determining the country's name or TV standard. If the query was answered with or the received information has feasible data, then the process continues at step 509; otherwise the process proceeds to step 506. The “Frequency Set?”—Step 506 is operable to control whether the specific frequencies for the mobile communication are determinable and, if yes, allow a determination of the country. Thus, if a country using these specific frequencies was determined, the process continues to step 509; otherwise to step 508. The “Message”—Step 508 is operable to inform the user that despite the availability of mobile communication frequencies no country name or country-specific data was determinable. Therefore, the process loops back to step 502. The “Name of country/region known”—Step 509 is operable to signal to the user that the name of the country or country-specific data was determined. Of course any other data available for determining the TV standard can be output to inform the user; even the TV standard itself when it was already determined by for example the user input device or the information receiving device. Afterwards the process continues to step 510. The “Map with TV standard”—Step 510 is operable to determine the TV standard of the country by linking the country name or country-specific data with an internal database described as mapping device 12 in FIG. 1. Of course, values other than the country name like for example the above-mentioned frequencies can be used to determine the name and eventually the TV standard of the country. Next, the process continues to step 511. The “Adjust converter to TV standard”—Step 511 is operable to set the TV signal converter device 3, as mentioned in FIG. 1, to the determined TV standard for converting the signal into said video signal.

Since this flow chart is only an example, the steps 502 to 506 can be arranged in any order a manufacturer and/or user wants them to. Moreover, this flow chart can be stopped at any point and/or looped for a predefined number.

All devices described in FIG. 5 are the same as described in FIG. 1.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A mobile communication equipment (1) adapted for wireless communication in a wireless communication system, comprising an analysing device (11) being operable to determine a television standard, said analysing device (11) comprising
a determining device (13) operable to automatically determine country-specific data, and
a mapping device (14) operable to map said country-specific data to a specific television standard.

2. A mobile communication equipment (1) according to claim 1,
wherein the determining device (13) determines said country-specific data via a user identification device (111).

3. A mobile communication equipment (1) according to claim 2,
wherein said user identification device (111) comprises a ID memory card device operable to store country-specific data.

4. A mobile communication equipment (1) according to claim 1,
wherein the determining device (13) determines said country-specific data from information received via the wireless communication system.

5. A mobile communication equipment (1) according to claim 4,
wherein said determining device (13) comprises an information receiving device (112) operable to receive country-specific data from a base station.

6. A mobile communication equipment (1) according to claim 1,
wherein the determining device (13) determines said country-specific data from country-specific characteristics of the wireless communication system.

7. A mobile communication equipment (1) according to claim 6,
wherein the determining device (13) comprises a frequency filter device (113) operable to determine the country-specific characteristics by means of a frequency determination.

8. A mobile communication equipment (1) according to claim 1, comprising
a user input device (12) operable to input country-specific data by a user.

9. A mobile communication equipment (1) according to claim 1, comprising
a television signal converter device (3) operable to convert television signals into video signals according to said determined television standard.

10. A mobile communication equipment (1) according to claim 9,
wherein the television signal converter device (3) is operable to process the television standards PAL, NTSC and SECAM.

11. A mobile communication equipment (1) according to claim 9, comprising
a television signal receiver device (2) operable to receive television signals.

12. A mobile communication equipment (1) according to claim 11,
wherein the television signal receiver device (2) comprises a storage device (21), said storage device (21) being operable to provide television signals to said television signal converter device (3).

13. A mobile communication equipment (1) according to one of the claim 9, comprising
a video signal output device (4) operable to output video signals.
